(19) United States
(12) Patent Application Publication
(10) Pub. No.: US 2007/0214104 A1
(43) Pub. Date: Sep. 13, 2007

(54) Method and system for locking execution plan during database migration

(76) Inventors: Bingjie Miao, Tigard, OR (US); David E. Simmen, San Jose, CA (US)

Correspondence Address: LIEBERMAN & BRANDSDORFER, LLC, 802 STILL CREEK LANE, GAITHERSBURG, MD, 20878, US

(21) Appl. No.: 11/369,394

(22) Filed: Mar. 7, 2006

(51) Int. Cl. G06F 17/30

(52) U.S. Cl. 707/2

(57) ABSTRACT

A method and system are provided for optimizing a query migrated from a source database system to a possibly dissimilar target database system, wherein the execution plan chosen for the migrated query is communicated from the source database system. Explain facilities of the source database system are used to gather information describing the execution plan used in the source database system for the migrated query. The explain information is then used to obtain plan directives for communicating the execution plan to the optimizer of the target system. If the obtained plan directives require auxiliary data structures, the source system catalogs are queried to determine the attributes of these auxiliary structures. These attributes are then used to create equivalent auxiliary structures in the target system. The migrated query is then optimized using the obtained plan directives, thus enabling database migration to preserve the investment made in tuning the execution plan on the source system

### BACKGROUND OF THE INVENTION

1. Technical Field

This invention relates to migration of databases. More specifically, the invention relates to preserving execution plans present in a source database to a target database.

2. Description of the Prior Art

A database is a collection of information organized to enable a computer program to quickly select desired data. Traditional databases are organized by fields, records, and files. A field is a single piece of information. A record is one complete set of fields. A file is a collection of records. To access information from a database, a collection of programs are used to enable entering, organizing, and selecting data in a database. Relational database systems store large amounts of data, including business data that can be analyzed to support business decisions. Data records within a relational database management system in a computing system are maintained in tables, which are a collection of rows all having the same columns. Each column maintains information on a particular type of data for the data records which comprise the rows. Auxiliary structures, such as indexes and materialized views, can be defined on a table or set of tables. A list of keys, or keywords, may be provided wherein each key or keyword identifies a set of records. The list of keys or keywords together with corresponding record identifiers is known as a database index, hereinafter referred to as an index. Database indices make it faster to find specific records and to sort records by the field used to identify the records. The results of a query can be pre-computed and saved in a result set as an auxiliary structure known as materialized views. A materialized view can significantly reduce query execution time since a portion of the query has been pre-computed.

Typically, a database includes catalog tables and base tables. The catalog tables store data that describes base tables. The base table is a table within the database that stores operator accessible and identifiable data. Data stored in the catalog tables pertains to meta-data. In the case of a database, the meta-data is in the catalog tables and describes operator visible attributes of the base table, such as the names and types of columns. Moreover, the meta-data in catalog tables describes attributes of auxiliary structures such as indexes and materialized views. The catalog tables and base tables function in a relational format to enable efficient use of data stored in the database.

Modern databases include a program component called an optimizer to select an execution plan to produce a desired result set from the database. Typically the optimizer uses meta-data in the catalog tables to determine available auxiliary structures for accessing tables, and for estimation of cost for an execution plan. Ideally, the optimizer minimizes the time required to select an execution plan from among all possible selections, and the cost required to execute the selected execution plan, wherein cost may include elapsed time, or system resources consumed. The output of the optimizer is an execution plan, which is composed of operators. Such operators may include operators for performing a sequential scan of a table, operators for using indexes to access a table, operators for joining tables via methods such as nested-loop join, hash join or merge-join, and a variety of other operators required to implement the query efficiently. One of the key determinants of cost is how the query optimizer composes operators into execution plans. For example, in one embodiment, the optimizer determines the operators for accessing tables, joining tables, and the order in which tables are joined. Most database systems that implement a similar data model, e.g. the relational data model, support a congruent set of such operators.

Different execution plans can have orders of magnitude of differences in execution efficiency. The optimizer may choose an inefficient execution plan due to deficiencies in its cost model. Therefore, most database systems support ways to influence the optimizer, referred hereafter as plan directives.

Given the selection of database systems available, it has become common in the art to migrate from one database system, i.e. a source system, to a target database system. The source and target database systems typically implement a similar data model, e.g. relational, but are often supplied by different database vendors. Thus, the source and target systems are often dissimilar in terms of the query dialect they use, their storage architecture, and other aspects of the system related to a vendors particular implementation of the data model.

One prior art solution for migrating between database systems focuses exclusively on the migration of data and applications. The process of migrating data involves replicating tables of the source system to the target system. Migrating applications involves converting queries and procedures from the dialect of the source system to the dialect of the target system. After data and applications are migrated, the optimizer of the target system determines execution plans for migrated queries. The execution plan chosen for a migrated query by the optimizer of the target system may differ dramatically from the one chosen by the optimizer of the source system due to differences in the quality of their cost models, the sophistication of their optimization algorithms, and so on. Significant time and effort must be spent tuning query performance in cases where the execution plan chosen for the migrated query by the target system optimizer is dramatically less efficient than the execution plan chosen by the source system optimizer. The labor-intensive process of performance tuning is costly, as it must be undertaken by a highly skilled database administrator. The prior art database migration solution does not address lowering migration costs by exploiting the significant time and effort already spent tuning the query on the source system. In particular, the prior art solution does not address lowering migration costs by leveraging execution plans in the source system and communicating the execution plans to the target system in an interpretable manner.

Assuming an execution plan on the source system provides satisfactory performance, it is possible to direct the optimizer of the target system to choose an equivalent execution plan to provide satisfactory performance on the target system. An equivalent execution plan should include the equivalent methods for accessing each table, the equivalent methods for joining those tables, as well as an equivalent join ordering as the execution plan used in the source system.

Therefore, there is a need for enabling migration between dissimilar databases systems that communicates execution plans while mitigating costs associated therewith.

### SUMMARY OF THE INVENTION

This invention comprises a method and system for optimizing a query migrated from a source database system to a potentially dissimilar target database system, wherein the execution plan chosen by the target system optimizer for the migrated query is communicated from the source database system

In one aspect of the invention, a method is provided for optimizing a query migrated from a source database system to a possibly dissimilar target database system. A description of the execution plan used for the migrated query in the source database system is obtained and communicated to the target system. The obtained execution plan description is then used to obtain attributes of auxiliary structures used by the communicated execution plan. Auxiliary structures are created on the target system using the attributes of the auxiliary structures that are equivalent to the auxiliary structures used by the execution plan in the source system. The communicated execution plan and the equivalent auxiliary structures created on the target system are used to generate an equivalent execution plan on the target system.

In another aspect of the invention, a computer system is provided with a target database system and a query migrated from a possibly dissimilar source database system. A manager is provided to obtain a description of the execution plan used to implement the query on a source system and to communicate the execution plan to the target system. The manger is further adapted to use the obtained execution plan description to obtain auxiliary structures used by the execution plan to create the obtained auxiliary structures on the target system. An equivalent execution plan may be generated on the target system based upon the communicated execution plan and the target system auxiliary structures.

In yet another aspect of the invention, an article is provided with a computer readable medium. Instructions are provided to obtain a description of the execution plan used to implement a query in a source database system, and to communicate the execution plan to a possibly dissimilar target system. In addition, instructions in the medium are provided to use the description of the execution plan to obtain auxiliary structures used by the execution. Additional instructions in the medium are provided to use the obtained attributes to create equivalent auxiliary structures in the target system. Finally, instructions in the medium are provided to use the communicated execution plan and the auxiliary structures created on the target system to generate an equivalent execution plan on the target system.

Other features and advantages of this invention will become apparent from the following detailed description of the presently preferred embodiment of the invention, taken in conjunction with the accompanying drawings.

### BRIEF DESCRIPTION OF THE DRAWINGS

FIG. 1 is a flow chart illustrating a process for optimizing a query migrated from a source database system to a target database system according to the preferred embodiment of this invention, and is suggested for printing on the first page of the issued patent.

FIG. 2 is a block diagram illustrating placement of a migration manager in the system.

### DESCRIPTION OF THE PREFERRED EMBODIMENT

### Overview

It has become common in the art for a database to be migrated across a network from a source system to a target system, wherein the source and target systems are dissimilar database platforms. In one embodiment dissimilar database platforms may include that the source and the target are supported by different vendors. Most database systems support similar sets of query evaluation operators for accessing tables, joining tables, sorting results, and so on. A query optimizer, hereinafter optimizer, in a database system determines how these operators are composed into execution plans. For example, the optimizer may determine preferable operators for accessing tables, joining tables, and the order in which the tables are joined. Although most systems that implement a relational data model support a congruent set of such operators having comparable performance, the difference in performance between an optimal and sub-optimal arrangement of these operators in an execution plan can be several orders of magnitude. Data that explains how a query is executed in a source system can be obtained from the source system. When migrating a database from a source system to a target system, it is desirable to capture this data and to utilize it to efficiently run the query with an equivalent execution plan in the target system following the migration.

### Technical Details

SQL is a standardized query language for creating, modifying, and requesting information from a database. SQL is a declarative language in that it specifies what data is desired, not how to obtain it. The query optimizer is the component of a relational database management system that determines the most efficient way to obtain the data needed to satisfy an SQL query. The output of the optimizer is called an execution plan. Virtually all database systems provide a capability to capture information about an execution plan for a query submitted from either static or dynamic database application environments. The captured information, also know as explain information enables the user to understand how a database manager implements an SQL query and to evaluate user oriented performance-tuning actions. Most database systems also provide a capability to directly influence the execution plan chosen by the optimizer. This capability is known as plan directives. By leveraging the explain information in the source system and communicating this data to the target system via plan directives, the execution plan may be preserved. If the preserved execution plan relies on the use of auxiliary structures such as indexes and materialized views, the process of preserving the execution plan requires an additional step of creating equivalent auxiliary structures on the target database system prior to optimization of the query.

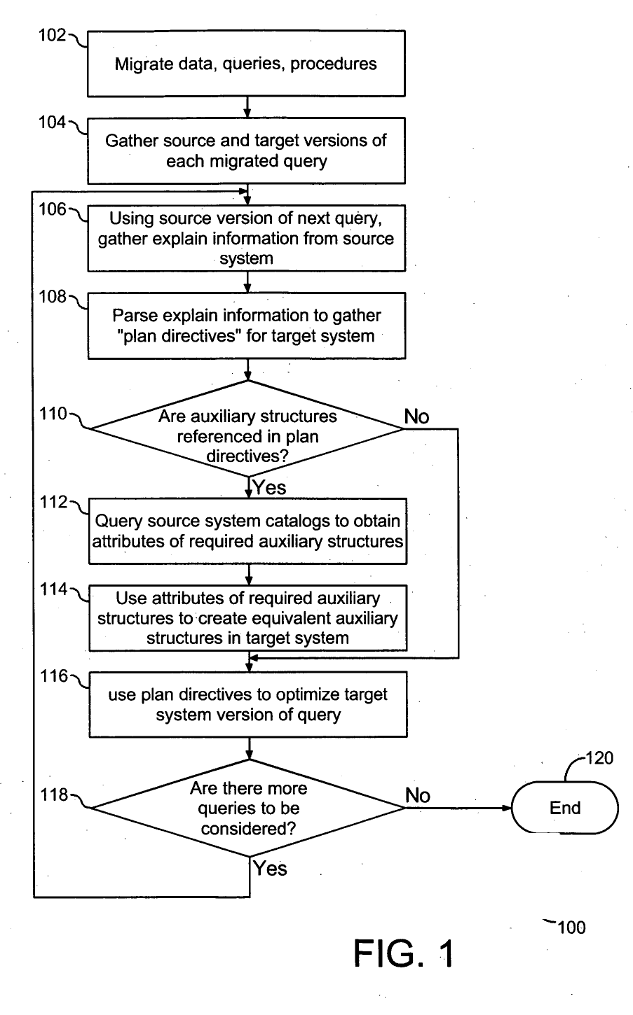

FIG. 1 is a flow chart (100) illustrating a process for migrating from a source database to a target database while preserving the execution plans present in the source database. Initially, data, queries, and procedures are migrated from the source database to the target database (102). This migration generally includes replicating database tables from the source to the target database system, and the translation of queries and procedures from the dialect of the source system to the dialect of the target system. Following the migration of data, queries, and procedures, the source and target system versions of each migrated query is gathered for evaluation (104). For a first query, the source version of the query is used to gather explain information from the source system (106). Explain information is a description of a query plan as conveyed from the optimizer to the user. The explain information gathered at step (106) will include instructions describing how the data should be accessed and processed in the system to efficiently and accurately obtain the requested data. The explain information is then parsed to obtain plan directives (108). In one embodiment, these instructions may include preserving an order of join instructions, a method used for each join, a table access method for each table in the query, etc. The intention is to generate plan directives for each query migrated to the target system so that an execution plan equivalent to the one used in the source system can be generated on the target system. Following the parsing of explain information at step (108), it is determined if the parsed plan directives in the source system reference one or more auxiliary structures in the source system (110). In one embodiment, an auxiliary structure may be a table index that is present on the source system, but may not have been migrated to the target system. In another embodiment, an auxiliary structure may be a materialized view defined on the source system. If the parsed plan directives reference one or more auxiliary structures, the source system catalog tables are queried to obtain attributes needed to define equivalent auxiliary structures in the target system (112). Following step (112), these referenced auxiliary structures are created in the target system (114). In one embodiment, the target system may use data definition language (DDL) to generate the auxiliary structures. However, if the plan directives do not reference an auxiliary structure or following the creation of one or more referenced auxiliary structures in the target system, the target system version of the migrated query is optimized using the plan directives (116), such that the optimizer on the target system will generate an equivalent execution plan for the migrated query. Following step (116), it is determined whether there are any additional queries in the source system that need to be reviewed (118) so that plan directives of the non-reviewed queries can be generated on the target system. A positive response in step (118) causes the process to proceed to step (106), and a negative response in step (118) will end the evaluation (120). Accordingly, execution plans for each migrated query are gathered and parsed to generate plan directives, auxiliary structures required by those plan directives are created on the target system, and the migrated query is optimized on the target system using the generated plan directives to ensure that the execution plan used for the migrated query in the source system is maintained in the target system.

The following is a set of examples illustrating migration from a source database to a target database. In particular, it describes how an execution plan might be migrated from Oracle to DB2 for Linux, Unix, and Windows (DB2). Example 1 shows the definitions of two Oracle tables, T1 and T2, along with the definition of a unique index T213 on column I3 of table T2. Example 1 also shows an Oracle query requesting data from the defined tables.

### EXAMPLE 1

oracle Table definitions

create table T1 (I1 number(38), I2 number(38))

create table T2 (I3 number(38), I4 number(38))

create unique index T213 on T2(I3);

Oracle Query definition

select *

from T1, T2

where T1.I1=T2.I3 and T1.I4>5;

Example 2 shows equivalent DB2 definitions for the Oracle tables defined in Example 1. It also shows the DB2 version of the Oracle query defined in Example 1. Although it is not the case in general, in this example, the migrated DB2 query has the same syntax as the Oracle query.

### EXAMPLE 2

DB2 Table definitions

create table T1 (I1 integer, I2 integer)

create table T2 (I3 integer, I4 integer)

DB2 Query definition

select *

from T1, T2

where T1.I1=T2.I3 and T1.I4>5;

Example 3 shows the Oracle explain statement used to obtain a description of the execution plan chosen by the Oracle optimizer for the query of Example 1.

### EXAMPLE 3

explain plan for STATEMENT_ID=‘TEST’

select *

from T1, T2

where T1.I1=T2.13 and T1.I4>5;

Oracle places explain statement results in a special table called a plan table. An explain statement is a command presented to the optimizer requesting explain information. All databases have explain statements, but may be presented in different formats. For example, Oracle presents explain statements in a table format, but other databases may present the explain statement in different formats. Each row deposited in the plan table corresponds to a specific operator used in an Oracle execution plan. The most significant fields of the table are the OPERATION, OBJECT_NAME, OPTION, ID, and PARENT_ID fields. The OPERATION field gives the name of the execution plan operator. The OBJECT_NAME field defines what object the operator works on, or with. The OPTION field gives more detailed information about the operation performed by the operator. The ID and PARENT_ID fields are used to indicate how the individual operators are composed into an execution plan. If the ID field of a row is referenced in the PARENT_ID field of another row, it implies that operator represented by the first row takes input from the operator represented by the second row. Example 4 shows possible explain output for the statement of Example 1.

### EXAMPLE 4

Output from plan:

| ID | PARENT_ID | OPERATION | OPTIONS | OBJECT_NAME |
|---|---|---|---|---|
| 0 | | Select | | |
| | | Statement | | |
| 1 | 0 | Nested Loops | | |
| 2 | 1 | Table Access | Full | T1 |
| 3 | 1 | Table Access | By Index | T2 |
| | | | Row Id | |
| 4 | 3 | Index | Unique Scan | T2I3 |

5 rows selected.

The explain output in Example 4 indicates that the Oracle optimizer has chosen to join tables T1 and T2 using a nested-loop join operation, with T1 playing the role of the outer table and T2 the role of the inner table. The explain output also indicates that T1 is to be accessed using a full table scan, and that T2 will be accessed using unique index T213. The hierarchical structure of the execution plan is defined by the ID and PARENT_ID relationships as described above. Both of the records representing table access operations (ID=2 and ID=3) reference the nested-loops join operation (ID=1) with their PARENT_ID fields. This indicates that the results of the corresponding table access operations feed the nested-loop joins operation. Moreover, since the record representing the access to table T1 (ID=2) has an ID field value that appears before the ID field value of the record representing the access to T2 (ID=3), T1 is interpreted as the outer table of the nested-loops join operation. The index record (ID=4) indicates that the T213 index is used in the table access to T2 (ID=3) by way of its PARENT_ID field reference.

Example 5 illustrates the DB2 plan directives that would be generated from the Oracle explain output in order to obtain an equivalent execution plan on DB2.

### EXAMPLE 5

<OPTGUIDELINES>

<NLJOIN>

<TBSCAN TABLE=“T1”/>
<IXSCAN TABLE=“T2” INDEX=“T2I3”>

</NLJOIN>

</OPTGUIDELINES>

DB2 plan directives are specified using XML. Each XML element inside the <OPTGUIDELINES> and </OPTGUIDELINES> elements represents a desired execution plan operation. Moreover, the order in which elements are nested within other elements represents the desired composition of operators. In the example, the NLJOIN element requests DB2 to do a nested-loop join operation, the TBSCAN operator requests a full table scan for the table T1 (identified by the TABLE attribute of the element) and the IXSCAN operator requests that T2 be accessed using index T213 (identified by the INDEX attribute of the IXSCAN element). Since the TBSCAN element appears before the IXSCAN element within the NLJOIN element, T1 will play the role of the outer table in the nested-loop join operation. Thus, the given plan directives will cause the DB2 optimizer to choose an execution plan equivalent to the Oracle execution plan in terms of access methods, join method, and join order.

Prior to optimizing the DB2 version of the query using the plan directives of Example 4 as input, an index equivalent to the Oracle index defined in Example 1 would be defined in the DB2 system. The attributes needed to define the index, i.e. the table index, the indexed columns, unique attribute, etc., would be determined by examining relevant Oracle data dictionary tables, e.g. the USER_IND_COLUMNS table. There is sufficient information in the Oracle data dictionary to re-engineer the definition of the Oracle index and hence, to define an equivalent DB2 index. In this example, the syntax of the statement which would generate an equivalent DB2 index is the same as the Oracle index definition shown in Example 1. In one embodiment, it is not important that the Oracle and DB2 versions of the index share the same index name.

In one embodiment, the process of explaining the query on Oracle, the generation of the DB2 plan directives, and the definition and creation of the required index would be automated. The plan directives shown in Example 5 could be provided to the DB2 optimizer either by embedding the XML specification in an SQL comment, or in an optimization profile.

The invention can take the form of a hardware embodiment, a software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk read only memory (CD-ROM), compact disk B read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

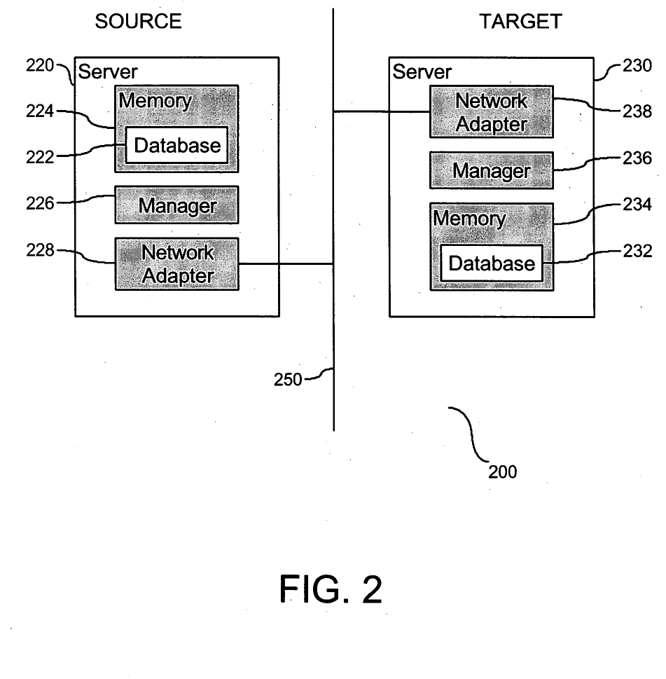

In one embodiment, a migration manager is provided in software or hardware. With respect to the software implementation, the manager may include, but is not limited to, firmware, resident software, microcode, etc. The software implementation can take the form of a computer program product accessible from a computer-useable or computer-readable medium providing program code for use by or in connection with a computer or any instruction execution system. FIG. 2 is a block diagram (200) illustrating placement of the manager in the system hardware. The illustration shows a source system with a server (220) and a target system with a server (230). As shown, the source system server (220) and the target system server (230) are in communication across a network (250) through a network adapter (228) and (238), respectively. Source system data and queries may be migrated to the target system (230) across the network through the associated network adapters (228) and (238). Both the source system (220) and the target system (230) each include memory (224) and (234), respectively, with a database located therein. As shown, the source server (220) includes a source database (222) in memory (224), and the target server (230) includes a target database (232) in memory (234). The source system memory (224) includes a manager (226) embedded therein, and the target system memory (234) includes a manager (236) embedded therein. As noted above, in one embodiment the manager may be in system software in which case the source system manager (226) would be embedded within source system memory (224) and the target system manager (236) would be embedded within target system memory (234). Execution plans are obtained from the source system manager (226), and the target system manager parses the source system execution plans to generate plan directives. Subsequently, the generated plan directives may be associated with the query migrated to the target system through the target system manager (236). In addition, the target system manager may oversea creation of any auxiliary structures on the target system referenced from the generated plan directives.

For the purposes of this description, a computer-useable or computer-readable medium can be any apparatus that can contain, store, communicate, propagate, or transport the program for use by or in connection with the instruction execution system, apparatus, or device.

### Advantages Over The Prior Art

The prior art processes for migrating a database from a source system to a target system do not address how to influence the optimizer of the target system in order to generate an equivalent execution plan for a migrated query. Each database system has its own optimizer that may be influenced using different techniques to execute a query. The process outlined herein influences the optimizer in the target system to generate an equivalent execution plan as in the source system, thereby preserving the investment made in tuning the query on the source system and reducing the cost of migration.

### Alternative Embodiments

It will be appreciated that, although specific embodiments of the invention have been described herein for purposes of illustration, various modifications may be made without departing from the spirit and scope of the invention. In particular, the plans of a query could be represented using an optimization profile. Accordingly, the scope of protection of this invention is limited only by the following claims and their equivalents.

We claim:

1. A method of optimizing a query migrated from a source system to a target system, comprising:
obtaining a description of an execution plan from the source system used to implement the query on the source system and communicating said execution plan to said target system, wherein said source and target systems operate on dissimilar database platforms;
obtaining from the source system the attributes of auxiliary structures used by said communicated execution plan;
creating auxiliary structures on said target system equivalent to said auxiliary structures used by the execution plan in the source system using said obtained attributes of auxiliary structures; and
using said communicated execution plan and said equivalent auxiliary structures created on said target system to generate an equivalent execution plan on said target system.

2. The method of claim 1, wherein the obtained auxiliary structures includes indexes and materialized views.

3. The method of claim 1, wherein said description of source system execution plan is communicated to said target system using directives for an optimizer of said target system.

4. The method of claim 3, wherein said directives include instructions to influence the target system optimizer to select a specific execution plan for a migrated query.

5. The method of claim 1, wherein said execution plan migrated to said target system and said source system execution plan include equivalent methods including accessing corresponding tables, joining corresponding tables, and joining corresponding tables in an equivalent order.

6. The method of claim 1, further comprising querying meta-data catalog tables to obtain a definition of said auxiliary structures created on said target system.

7. A computer system comprising:
a target system;
a query adapted to be migrated to said target system;
a manager adapted to obtain a description of an execution plan used to implement said query on a source system, and to communicate said execution plan to said target system, wherein said source and target systems operate on dissimilar database platforms;
said manager adapted to obtain auxiliary structures used by said execution plan and to create said obtained auxiliary structures on said target system; and
an equivalent execution plan adapted to be generated on said target system based upon said communicated execution plan and said target system auxiliary structures.

8. The system of claim 7, wherein said obtained auxiliary structures includes indexes and materialized views.

9. The system of claim 7, wherein said description of source system execution plan is communicated to said target system using directives for an optimizer of said target system.

10. The system of claim 9, wherein said directives include instructions to influence the target system optimizer to select a specific execution plan for a migrated query.

11. The system of claim 7, wherein said execution plan migrated to said target system and said source system execution plan include equivalent methods including accessing corresponding tables, joining corresponding tables, and joining corresponding tables in an equivalent order.

12. The system of claim 7, further comprising a catalog adapted to be queried to provide a definition of said target system auxiliary structures.

13. An article comprising:
a computer readable medium;
instructions in the medium for obtaining a description of an execution plan used to implement a query and communicating said execution plan from a source system to a target system, wherein said source and target systems operate on dissimilar database platforms;
instructions in the medium for obtaining auxiliary structures used by the execution plan;
instructions in the medium for creating auxiliary structures on said target system equivalent to said obtained auxiliary structures; and
instructions in the medium for using said communicated execution plan and said auxiliary structures created on said target system to generate an equivalent execution plan on said target system.

14. The article of claim 13, wherein the obtained auxiliary structures include indexes and materialized views.

15. The article of claim 13, wherein said description of source system execution plan is communicated to said target system using directives for an optimizer of said target system.

16. The article of claim 15, wherein said directives include instructions to influence the target system optimizer to select a specific execution plan for a migrated query.

17. The article of claim 13, wherein said execution plan migrated to said target system and said source system execution plan include equivalent methods including accessing corresponding tables, joining corresponding tables, and joining corresponding tables in an equivalent order.

18. The article of claim 13, further comprising querying catalog tables to obtain a definition of said auxiliary structures created on said target system.
